(19) United States
(12) Patent Application Publication
(10) Pub. No.: US 2006/0222762 A1
(43) Pub. Date: Oct. 5, 2006

(54) Inorganic waveguides and methods of making same

(76) Inventors: Kevin Paul McEvoy, Ballston Spa, NY (US); James Scott Vartuli, Rexford, NY (US); Samhita Dasgupta, Niskayuna, NY (US); Brian Lee Lawrence, Clifton Park, NY (US)

Correspondence Address: Patrick S. Yoder;FLETCHER YODER, P.O. Box 692289, Houston, TX, 77269-2289, US

(21) Appl. No.: 11/092,303

(22) Filed: Mar. 29, 2005

(51) Int. Cl. B05D 5/06; B05D 3/02

(52) U.S. Cl. 427/162; 427/372.2

(57) ABSTRACT

A method of forming a patterned optical transmission device on a substrate includes forming a liquid phase pattern on the substrate. The liquid phase pattern comprises a fluid precursor having a suspension or a solution of a dopant in a solvent. Catalyzing the liquid phase pattern to convert the liquid phase pattern into a hardened pattern, and processing the hardened pattern to form a patterned optical transmission device.

### BACKGROUND

The invention relates generally to optical device structures. In particular, the invention relates to inorganic waveguides and methods of making the same.

Waveguides are used in many applications for the transmission and channeling of light. In certain applications, such waveguides can form part of what may be considered the optical equivalent of printed electronic circuits. In general, they are paths along which optical signals travel. Typically, it is desirable to construct waveguides paths or footprints such that they occupy minimum space, thereby resulting in compact design of the waveguides and the devices employing waveguides. However, surface geometry of waveguide paths plays an important role in efficiency of waveguides, particularly when attempting to minimize the footprints the waveguide occupies. While traversing the waveguide paths, some optical signals are lost due to scattering from rough surfaces of the waveguide paths, and sensitivity to these scattering losses is increased in small form-factor guides with tight bend radii. To reduce the loss of optical signals through the waveguides, it is generally desirable to provide smooth surfaces and to control the surface geometry of the waveguide paths.

Several methods are conventionally employed in fabrication of waveguides. In one method, waveguides are made by forming a pattern on a substrate using photolithography and subsequently covering the patterned substrate with another substrate. In another method, typically known as photo-polymerization, waveguide-forming films with mobile monomers and polymer binders along with initiators and other constituents are pre-coated on a substrate film. The film is then exposed to radiation, causing photo-polymerization in the exposed areas that will become the wave paths.

Another method of making such structures is reactive ion etching, which is usually useful in semiconductor industries for forming very small structures on a substrate. Reactive ion etching is a dry process in which gas is accelerated towards a surface to etch away portions to define a structure. While such conventional techniques are useful in forming certain types of waveguides, many of these techniques are expensive, require relatively sophisticated apparatus, are not accurate, and are time consuming. Moreover, these processes also limit the refractive index difference that is desirable between the pattern and the substrate, thereby resulting in larger bend radii and larger overall footprints of the waveguides. Also, in making waveguides in these manners, it is difficult to control the surface geometry and texture accurately.

Accordingly, there is a need for a suitable method that addresses some or all of the problems set forth above.

### BRIEF DESCRIPTION

In accordance with one aspect of the present technique, a method of forming a patterned optical transmission device on a substrate is provided. The method comprises forming a liquid phase pattern on the substrate. The liquid phase pattern includes a fluid precursor having a suspension or a solution of a dopant in a solvent. Further, the method includes catalyzing the liquid phase pattern to convert the liquid phase pattern into a hardened pattern, and processing the hardened pattern to form a patterned optical transmission device.

In accordance with another aspect of the present technique, a method of forming a patterned optical transmission device on a substrate includes disposing a mold on the substrate, where the mold has least one cavity. A fluid precursor is disposed inside the cavity. The mold is removed from the substrate to expose the liquid phase pattern. The liquid phase pattern is converted into a hardened pattern by catalyzing. The hardened pattern is then heated and sintered.

In accordance with yet another aspect of the present technique, a method of forming a patterned optical transmission device on a substrate includes forming a liquid phase pattern on the substrate, and catalyzing the liquid phase pattern to convert the liquid phase pattern into a hardened pattern and to fix the liquid phase pattern.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional view of an exemplary optical waveguide according to certain embodiments of the present technique;

FIG. 2 is a diagrammatical representation of an exemplary liquid phase pattern on a substrate according to certain embodiments of the present technique;

FIG. 3 is a flow chart illustrating a method of forming a patterned optical transmission device on a substrate according to certain embodiments of the present technique;

FIG. 4 is a perspective view of the mold disposed on the substrate according to certain embodiments of the present technique; and

FIG. 5 is a diagrammatical representation of a laser employing lenses according to certain embodiments of the present technique.

### DETAILED DESCRIPTION

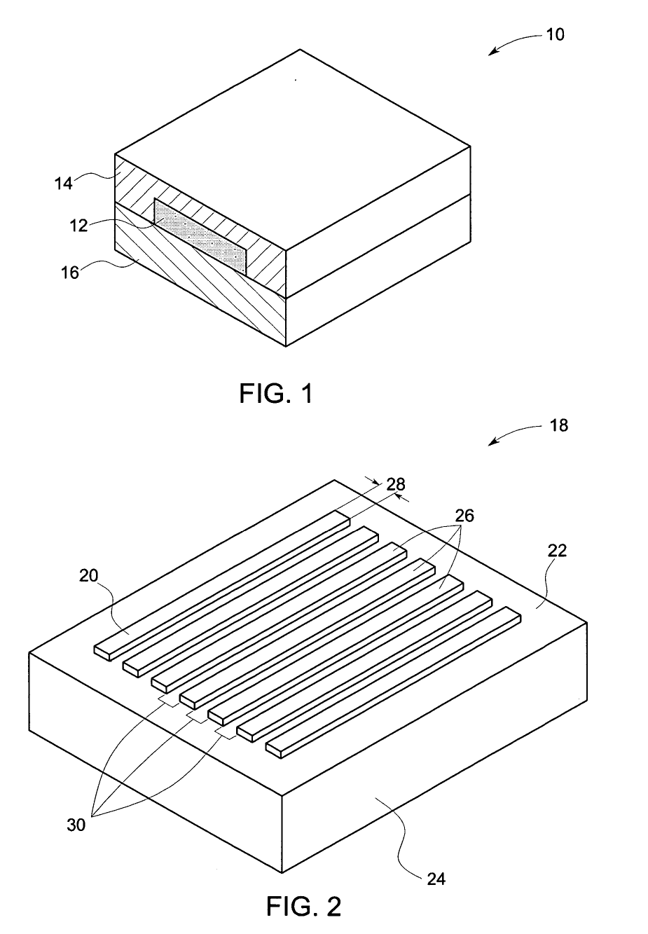

FIG. 1 is a cross sectional view of an exemplary patterned optical transmission device, such as an optical waveguide device 10 having a patterned region known as a core or a waveguide area 12. Typically, the core 12 is disposed between two layers that are generally referred to as upper and lower claddings 14 and 16. The core 12 is generally defined as an area located inside the optical waveguide 10 where the optical signals traverse. Typically, the waveguide area 12 is used to guide the optical signals entering the waveguide 10 from one point to another in the waveguide 10 and the upper and lower claddings 14 and 16 are used to confine any propagating light to the waveguide area 12 thereby, avoiding loss of signals into the surrounding space and enhancing the light output of the optical waveguide device 10.

Typically, the core 12 is formed by patterning one of the upper cladding 14 or the lower cladding 16. As described in greater detail below, in certain embodiments, the pattern may be formed by employing a liquid phase pattern on the upper or lower cladding. Subsequently, the second cladding or the non-patterned cladding may be disposed above the pattern to form a waveguide structure.

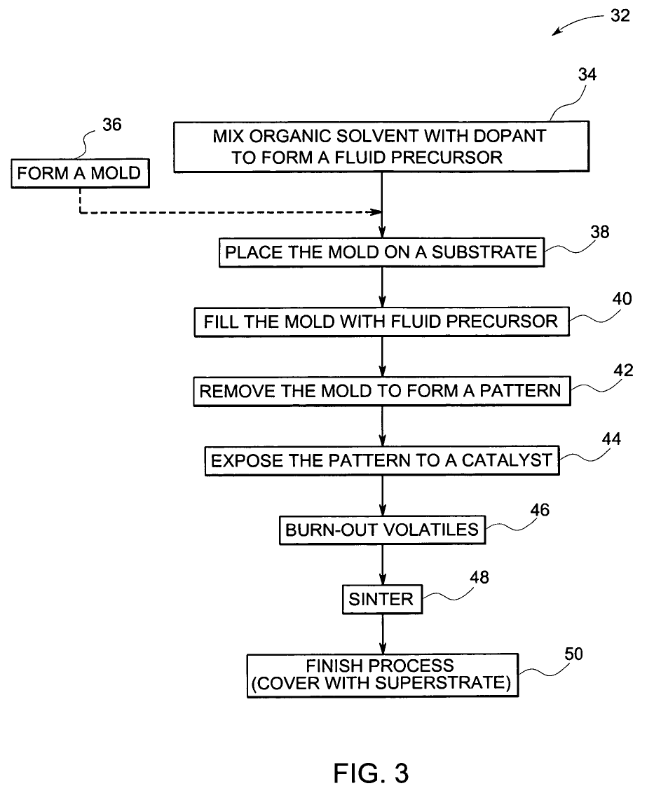

FIG. 2 illustrates an exemplary configuration 18 having a liquid phase pattern 20 disposed on a patternable surface 22 of the substrate 24. As used herein “liquid phase pattern” refers to a pattern having a physical state similar to that of a sol-gel such that the pattern is configured to retain its shape on its own in absence of any external support. In certain embodiments, the liquid phase pattern 20 is formed by a liquid precursor having a dopant. A method for making such a pattern 20 will be described further herein with reference to FIG. 3. In the illustrated embodiment, the liquid phase pattern 20 includes a plurality of bar patterns 26 separated by unpatterned regions 30. In one embodiment, the plurality of bar patterns 26 may have a predetermined width 28, wherein the width may vary in a range from about 1 micrometer to about 2.5 centimeters. Although not illustrated, as will be appreciated by those of ordinary skill in the art, the liquid phase pattern 20 may acquire various shapes, such as globules, lines. In certain embodiments, the substrate 24 may be a polymeric substrate or a glass substrate. In some embodiments, the substrate 24 may have a flat patternable surface 22, whereas in other embodiments, the substrate 24 may have a non-flat patternable surface. In some embodiments, the substrate 24 may have a combination of flat and non-flat patternable surfaces. Moreover, the substrate 24 may be a rigid or a flexible substrate depending upon the requirement of the product.

FIG. 3 is a flow chart illustrating an exemplary process 32 of forming a patterned optical transmission device structure on a substrate 24. As illustrated, the process 32 begins at step 34 by forming a fluid precursor. Typically, the fluid precursor is a source/precursor of the material forming the patterned structure on the substrate 24. The fluid precursor may include one or more chemical, or biochemical species depending on the purpose and the end use of the resulting final materials. For example, in certain embodiments including the fabrication of an optical device structure 10 (see FIG. 1), the fluid precursor may include an organic solvent and a dopant. In these embodiments, the dopant may be in a suspension or a solution state in the fluid precursor. In other words, the dopant may or may not be soluble in the solvent. For example, the fluid precursor may comprise a sol-gel precursor, or a colloidal solution having a suspension of the dopants. As will be appreciated by those of ordinary skill in the art, a sol-gel is typically a gel derived from a sol, either by polymerizing the sol into an interconnected solid matrix, or by destabilizing separate particles of a colloidal sol by an external agent. In certain embodiments, the fluid precursor comprises a silica based organometallic solution. In an exemplary embodiment, the fluid precursor comprises ethyl polysilane, such as ethyl ester of polysilane. Furthermore, in certain embodiments, the dopant may include a salt of a luminescent element such as rare earth metal, or transition metal, or both. In some embodiments, the dopant comprises an oxide of a photo-luminescent rare earth or transition metal element, such as cerium, praseodymium, neodymium, samarium, europium, gadolinium, terbium, dysprosium, holmium, erbium, thulium, ytterbium, titanium, chromium, manganese, or combinations thereof. Typically, these elements may exhibit luminescent properties in matrices, such as silica matrices. Consequently, when employed in a patterned optical transmission device, such as optical waveguide device 10 (see FIG. 1), the dopants, due to their luminescent properties, may contribute to the light output of the device and thereby, advantageously enhance the light output of the device.

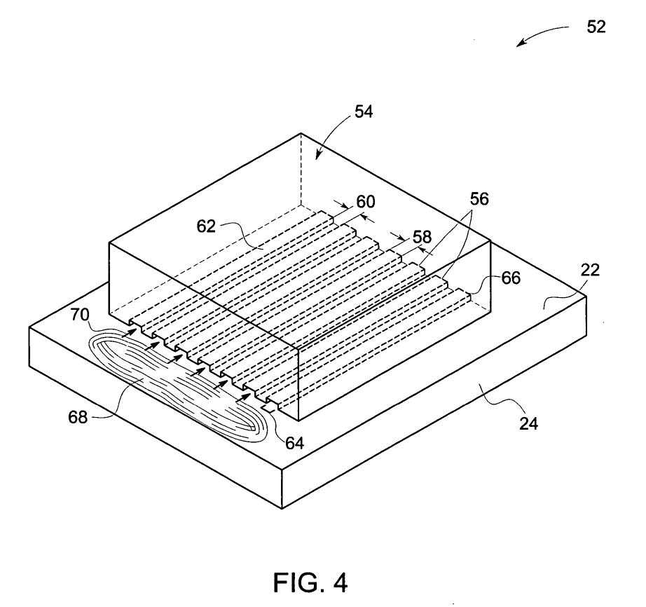

At step 36, a mold 54 (see FIG. 4) may be formed or provided to be employed in the process 32. In certain embodiments, the mold is employed to guide or transfer the fluid precursor onto the substrate in a predetermined pattern. In these embodiments, the mold has a substantially similar pattern as is desirable for the optical emission device. In other words, the pattern of the patterned optical transmission device formed by employing the mold 54 has dimensional features corresponding to the dimensional features of the indentations 56 of the mold 54. In the illustrated embodiment, the pattern of the fluid precursor 68 obtained by using the mold 54 is the liquid phase pattern 20 having a plurality of bar patterns 26 (see FIG. 2). For example, the width 58 of the indentations 56 is substantially similar to the width 28 of the bar patterns of the liquid phase pattern 26 of FIG. 2. As shown with reference to the arrangement 52 of FIG. 4, the mold 54 is positioned on the patternable surface 22 of the substrate 24. In one embodiment, the substrate 24 may be a lower cladding 16 (see FIG. 2) of the optical waveguide device 10. In the illustrated embodiment, the mold 54 includes a plurality of indentations or cavities, where any two adjacent indentations 56 are separated by a distance 60. Typically, the mold is made of a material which is non-reactive to the fluid precursor. For example, in one embodiment, the mold 54 is made of a polymer material such as, poly di-methyl siloxane (PDMS).

At step 38, the mold 54 is placed above the patternable surface 20 of the substrate 22 as shown in the contemplated configuration of FIG. 4. In the illustrated embodiment, the mold 54 includes a plurality of indentations or cavities 56. In this embodiment, the indentations 56 along with the patternable substrate 20 define channels 62. In the illustrated embodiment, each of the channels 62 has an opening or inlet 64 and an outlet 66. The inlet 64 is defined as an opening through which the fluid precursor is allowed to enter the channels 62, and outlet 66 is the side of the channel opposite the inlet 64. In the illustrated embodiment, the fluid precursor 68 is placed near the inlet 64 of the channels 62. As used herein, the term “near” is meant to define a proximate distance between the fluid precursor 68 and the inlet 64 of the channels 62, which facilitates unaided flow of the fluid precursor into the channels 62. However, as described in detail below, external force may be applied to facilitate the flow of the fluid precursor 68 into the channels 62.

At block 40, the channels 62 of the mold 54 are filled with the fluid precursor 68 by driving the fluid precursor into the channels 62. In some embodiments, capillary action may drive the flow of the fluid precursor 68 into the channels 62. In other embodiments, external forces such as an applied potential difference may be employed to draw the fluid precursor 68 into the channels 62 as represented by arrows 70. In these embodiments, the potential difference may be applied between the inlet 64 and outlet 66 of the channels 62. In certain embodiments, the fluid precursor may be drawn into the channels 62 by applying pressure, or creating a vacuum in the channels, thereby guiding the fluid precursor into the channels 62.

At step 42, subsequent to filling the mold 54 with the fluid precursor 68, the mold is removed from the patternable surface 22 of the substrate 20 to obtain a liquid phase pattern 20 of the patterned optical transmission device as shown in FIG. 2. Typically, the viscosity of the fluid precursor is maintained such that the liquid phase pattern retains its shape after removal of the mold 54 (see FIG. 4) while avoiding any structural damages caused by the mold removal. However, the relatively high viscosity of the fluid precursor inhibits the capillary action of the fluid precursor, thereby preventing it from entering the channels 62 in absence of any other driving forces, such as potential difference, vacuum or pressure.

At step 44, the liquid phase pattern 20 is hardened. Typically, the liquid phase pattern is hardened to the extent that it is self-supporting and can be employed in any patterned optical transmission device without further processing. In certain embodiments, the liquid phase pattern 20 may be hardened by exposing the same to a catalyst. Typically, upon reaction with the catalyst, the density of the fluid precursor increases thereby, providing more strength to the structure. In these embodiments, the liquid phase pattern 20 may be exposed to a gas phase catalyzer. In some embodiments, the gas phase stabilizer comprises ammonia.

At step 46, the hardened pattern is subjected to heat treatment also referred to as burn-out for the purpose of this application. As a result of this burn-out, the volatiles, such as carbon, present in the hardened pattern are removed, thereby converting the hardened pattern from organic into an inorganic hardened pattern. In certain embodiments, the burn-out may be performed at a temperature varying in a range from about 150° C. to about 300° C.

Subsequent to burn-out, at step 48, the hardened pattern is sintered to facilitate further densification of the pattern and thereby, improve the physical strength of the pattern. In certain embodiments, the sintering may be performed at a temperature varying in a range from about 400° C. to about 900° C. Consequently, at step 50, the process 32 may be completed by disposing a superstrate above the hardened pattern to cover the structure. For example, in case of waveguide 10, the upper cladding 14 (see FIG. 1) may be disposed above the lower cladding 16, after patterning the lower cladding to form the waveguide area 12 on the lower cladding 16.

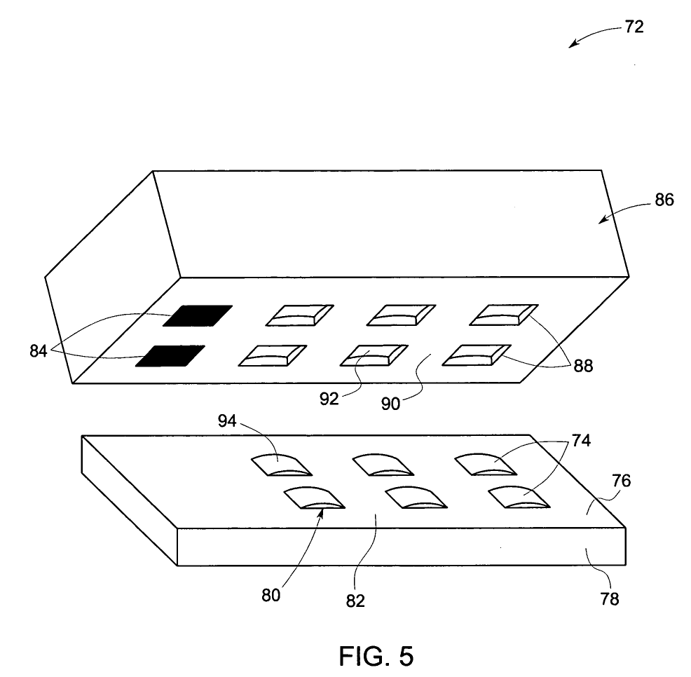

Although, the methods described above are with reference to patterned optical transmission devices, they may also be used to define an article incorporating a patterned substrate, such as shown in configuration 72 of FIG. 5. In the contemplated configuration 72 of the illustrated embodiment, an array of lenses 74 is disposed above a patternable surface 76 of the substrate 78. In this embodiment, the array of lenses 74 may have a plurality of individual lenses 80 which are separated by a region 82 on which the lenses 80 are formed. In certain embodiments, the array of the lenses 74 may be formed by transferring the fluid precursor 84 from the mold 86 onto the patternable surface 76 of the substrate 78. In the illustrated embodiment, the fluid precursor 84 may be disposed in the indentations 88 prior to transferring the fluid precursor onto the patternable surface 76. In certain embodiments, the fluid precursor disposed in the individual lenses 80 may be same or different depending on the requirement of the final product. In the illustrated embodiment, the indentations 88 are separated by regions 90 in which the indentations are disposed. In certain embodiments, the indentations 88 have a concave surface 92 resulting in a curved surface 94 of the lenses 80. Although not illustrated, the indentations 88 of the mold 86 may vary in shape and size, thereby facilitating formation of an array of lenses 74 having varying dimensions.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of forming a patterned optical transmission device on a substrate, the method comprising:
forming a liquid phase pattern on the substrate, wherein the liquid phase pattern comprises a fluid precursor having a suspension or a solution of a dopant in a solvent;
catalyzing the liquid phase pattern to convert the liquid phase pattern into a hardened pattern; and
processing the hardened pattern to form a patterned optical transmission device.

2. The method of claim 1, wherein the substrate comprises a flat surface.

3. The method of claim 1, wherein the step of forming the liquid phase pattern comprises:
disposing a mold on the substrate, wherein the mold comprises at least one cavity;
disposing the fluid precursor in the mold; and
removing the mold prior to catalyzing the liquid phase pattern.

4. The method of claim 1, wherein the liquid phase pattern comprises plurality of lines, a plurality of globules, or both.

5. The method of claim 4, wherein the plurality of lines have a width in a range from about 1 micrometer to about 2.5 centimeters.

6. The method of claim 1, wherein the fluid precursor comprises a sol-gel precursor.

7. The method of claim 1, wherein the fluid precursor comprises a colloidal suspension.

8. The method of claim 1, wherein the fluid precursor comprises a silica based organic sol.

9. The method of claim 8, wherein the fluid precursor comprises an ethyl ester of polysilane.

10. The method of claim 1, wherein the dopant comprises a salt of a luminescent element.

11. The method of claim 10, wherein the luminescent element comprises a rare earth metal, or a transition metal, or both.

12. The method of claim 1, wherein the step of catalyzing comprises exposing the liquid phase pattern to a gas phase catalyzer.

13. The method of claim 12, wherein the gas phase catalyzer comprises ammonia.

14. The method of claim 1, wherein the step of processing the hardened pattern comprises:
burning-out the volatiles; and
sintering the hardened pattern.

15. The method of claim 14, wherein the step of burning-out comprises heating the hardened pattern at a temperature in a range from about 150° C. to about 300° C.

16. The method of claim 14, wherein the step of sintering comprises heating the hardened pattern at a temperature in a range from about 400° C. to about 900° C.

17. A method of forming a patterned optical transmission device on a substrate, the method comprising:
disposing a mold on the substrate, wherein the mold comprises at least one cavity;
disposing a fluid precursor inside the cavity of the mold, wherein the fluid precursor comprises a suspension or a solution of a dopant in an organic solvent;
removing the mold from the substrate to expose the liquid phase pattern;
catalyzing the liquid phase pattern to convert the liquid phase pattern into a hardened pattern;
heating the hardened pattern; and
sintering the hardened pattern.

18. The method of claim 17, wherein the step of disposing the fluid precursor inside the cavity comprises applying a potential across the mold.

19. The method of claim 17, wherein the step of heating comprises removing carbonaceous particles from the fluid precursor.

20. A method of forming a patterned optical transmission device on a substrate, the method comprising:
forming a liquid phase pattern on the substrate, wherein the liquid phase pattern comprises a fluid precursor solvent having a dopant in a suspension or a solution therein; and
catalyzing the liquid phase pattern to convert the liquid phase pattern into a hardened pattern and to fix the liquid phase pattern.
